(19) United States
(12) Patent Application Publication
(10) Pub. No.: US 2011/0135562 A1
(43) Pub. Date: Jun. 9, 2011

(54) TWO STAGE PROCESS FOR ELECTROCHEMICALLY GENERATING HYPOCHLOROUS ACID THROUGH CLOSED LOOP, CONTINUOUS BATCH PROCESSING OF BRINE

(75) Inventors: Marilyn J. Niksa, Chardon, OH (US); Andrew J. Niksa, Chardon, OH (US); Marc J. Epstein, Leonardo, NJ (US); Steven Seiden, Washington, DC (US)

(73) Assignees: Terriss Consolidated Industries, Inc., Asbury Park, NJ (US); Water Star, Inc., Newbury, OH (US)

(21) Appl. No.: 12/952,570

(22) Filed: Nov. 23, 2010

Related U.S. Application Data
(60) Provisional application No. 61/263,675, filed on Nov. 23, 2009.

(51) Int. Cl. C25B 1/26; C01B 11/04; C25B 9/00; C25B 15/00

(52) U.S. Cl. 423/473; 205/345; 204/267; 204/230.2

(57) ABSTRACT

High concentrations of hypochlorous acid can be produced from, most typically, brine using an system of simple design with minimum residual salt production, reduced power consumption, and at high operating efficiencies. This is accomplished by separating the system into two operations, each of which is preferably optimized. This process employs at least two electrochemical cells, the first of which has no separator between the anode and cathode and generates a high-strength hypochlorite solution. The hypochlorite is then diluted to a desired chlorine concentration and/or pH and fed into the anode compartment of a second electrochemical cell wherein the electrodes are separated by a barrier, such as, for example, a membrane or diaphragm. The separated cell produces a solution containing predominantly hypochlorous acid. Separation of the neutralization processes allows storage of hypochlorite which has a much greater stability in regards to temperature which can then be subsequently converted into hypochlorous acid at point of use or as needed or desired.

### REFERENCE TO RELATED APPLICATIONS

This application claims priority to U.S. Provisional Application No. 61/263,675 of the same title and filed Nov. 23, 2009, the entirety of which is hereby incorporated by reference.

### BACKGROUND

1. Field of the Invention

This invention is directed to devices, systems and methods for electrochemically generating hypochlorous acid and, in particular, the efficient generation of hypochlorous acid and with low residual salt.

2. Description of the Background

Chlorine has been used as a disinfecting agent for well over a century and chlorine residual is mandated for U.S. water supplies with more than 25 taps. The efficacy of chlorine as a disinfecting agent is based on the form the chlorine that exists in a given solution. The species are hypochlorous acid, hypochlorite and chlorine, and the prevalence of each form is pH dependent.

As shown in FIG. 1, from a pH of about 5 to 6.5, most of the chlorine is in the form of hypochlorous acid. Between 6.5 and 7.6, hypochlorous acid ranges from 92% down to 50%. Above pH 7.6, the majority of the chlorine is in the form of hypochlorite ion. Hypochlorous acid is a weak acid and dissociates in water to form hydrochloric acid and hypochlorous acid, which are in equilibrium. Typically, the maximum amount of hypochlorous acid available for disinfection is from a pH of about 5 to 6.5. Below this pH, the prevalent species is increasingly in the form of chlorine. Since the solubility of chlorine in water is relatively low, it is easily seen than excursions below a pH of about 4 pose substantial risk of chlorine off-gassing. White's Handbook of Chlorination and Alternative Disinfectants, 5th Edition, Black and Veatch Corporation (Wiley January 2010).

Hypochlorous acid (HOCl) is the most effective disinfectant of all the known chlorine species. Germicidal efficacy of this species is due to its relative neutrality which facilitates penetration into the cell walls of microorganisms. Hence the overall efficacy of disinfection is a function of pH which dictates the amount of HOCl and OCl⁻ in solution. The pH of the disinfecting solution is sufficiently low so that the prevalent species (say 75%) is HOCl or at about a pH of 5 to 7.1.

Various processes have been utilized to make chlorine species for disinfection. For example see U.S. Pat. Nos. 4,017,592; 4,146,578; 4,190,638; 4,584,178; 5,037,627; 5,270,019; 5,322,677; 6,773,575; and 7,658,834. In one such process, chlorine gas cylinders are transported to the site and chlorine injected into the water stream under pressure. The chlorine dissolves into the water forming hypochlorous acid and hypochlorite, depending on the pH and buffering capacity of the receiving water. However, the dangers of handling and transporting chlorine gas and the many personnel hazards it presented drove the development of alternative processes to make chlorine species on site. One such electrochemical device to generate hypochlorite on site is described in U.S. Pat. No. 5,753,198. As described therein, a cell consists of an anode and a cathode with no mechanical separation. Sodium chloride brine is fed to the device where it is electrolyzed between the electrodes to form sodium hypochlorite and hydrogen (which is off-gassed). The concentration of the sodium hypochlorite generated is about 0.8% and the overall current efficiency is 70 to 98%. Preferably, brine solution is pumped into the cell with a mechanical pump. Alternatively, the solution can utilize the gas lift of the hydrogen generated to provide the fluid movement for enhanced cell performance. The hypochlorite is then injected at a prescribed rate into the receiving waters. Preferably, the dose rate is 2 to 20 mg/L, the pH of the diluted stream is 6.8 to 7.4, meaning that much of the chlorine is in the form of hypochlorite. However, there are many situations where a higher proportion of hypochlorous acid is desired (more disinfecting power), generally at a higher mg/L, say 100 to 200 mg/L. In this situation the user acidifies the solutions using for example acetic or phosphoric acid, a somewhat clumsy equipment addition to an elegant electrochemical process.

The electrolyte is generally at a concentration of 20 to 30 grams per liter and in the form of sodium chloride. This is close to the salt concentration of seawater, which is about 35 grams per liter and can be used in lieu of mixing solutions of salt and water. These type devices have found wide acceptance for chlorine generation in remote areas and more recently are specified for municipal water supplies due to the increasing difficulty in transportation and handling of chlorine gas. Chlorinators of this type are sold under the names, for example, SANILEC®, CHLOROPAC®, and ELECTROCHLOR®. Depending as they do on the natural acidity of the dilution water to neutralize the bacidity of the generated hypochlorite solution, much of the chlorine species remains as hypochlorite instead of the more potent hypochlorous acid.

Processes have been developed to directly produce hypochlorous within a single electrochemical cell. These devices are described in U.S. Pat. Nos. 6,632,347 and 7,303,660. These systems generally operate by feeding low salinity brine from 1,000 to 10.000 mg/L as NaCl into the anode chamber of a separated cell. Hence the efficiency of chlorine generation is low as evidenced by FIG. 2 which shows current efficiency vs. salinity.

In these devices the separator typically is a ceramic diaphragm or an ion exchange membrane. Ceramic materials used are preferably tubes of an alumina or alumina/zirconia and membranes employed are the ion exchange type. Reactions at the anode and cathode are described below: pos Anode reactions:

Reaction 1: Cl⁻→Cl₂

Followed by Cl₂+H₂O→HClO₃ or HOCl− depending on the pH

Reaction 2: H₂O →O₂+H⁺

Cathode reaction:

Reaction 3: H₂O→H₂+OH⁻

Both chlorine and protons (acid) are formed at the anode, hydroxyl ions (base) are formed at the cathode. The two streams are kept apart by a separator that can be an ion exchange membrane, such as NAFION®, a porous diaphragm, or a ceramic separator. Control of the pH is essential to ensure that most of the chlorine species are in the form of hypochlorous acid. If the pH is too high then most of the chlorine will be in the form of hypochlorite, too low and chlorine gas will be emitted. The source of acid for this pH control is provided by the chlorine inefficiency (oxygen evolution/reaction 2) at the anode. Alkali formed at the cathode is used to control the anode acidity to the preferred range. These generators mix sufficient cathode material to that produced in the anode stream so as to exit the generator at a pH level where hypochlorous acid is the predominant species. Hence a complex regime on control is needed to ensure that the proper pH is obtained.

The device described in U.S. Pat. No. 5,871,623 utilizes a vertical coaxial cylindrical anode and rod cathode, plus a diaphragm of a ceramic material. Feed water is fed to the anode and cathode and said feed water is dosed with sodium chloride. An electrical current is passed between the electrodes and hypochlorous acid is formed. pH control is effected by mixing the cathode and anolyte materials. Hypochlorous acid concentration is in the range of 100 to 300 ppm and the salt concentration in the product can be from 1,000 ppm to 3,000 ppm. Salt concentration is important in many applications where salt is not desirable. For example, if the solution is used for animal health, high salt concentrations are detrimental; or if the hypochlorous acid solution is used for misting vegetables, salt causes damage to the produce.

There is a need for an efficient hypochlorous acid generation system that has a low salt residual. Also, since hypochlorous acid is not as stable as hypochlorite and decomposes more easily, there is also a need for a process that generates hypochlorous acid upon demand in a simple and efficient manner.

### SUMMARY OF THE INVENTION

The present invention overcomes the problems and disadvantages associated with present strategies and designs and provides new devices, systems and methods for electrochemically generating hypochlorous acid.

One embodiment of the invention is directed to processes for generating hypochlorous acid comprising: providing an alkaline metal chloride solution, such as brine with a chlorine content, to un-separated electrochemical cell containing electrodes to generate a first solution containing a hypochlorite; diluting the first solution with an aqueous liquid to form a diluted solution; and providing the diluted solution to a separated electrochemical cell containing electrodes that generates protons to form a second solution comprised of hypochlorous acid.

The initial solution preferably comprises about 15 to 40 grams per liter of an alkaline metal chloride such as NaCl, or may comprise seawater, manufactured salt water or softened water. The amount of dissolved solids and/or alkalinity in the brine solution may be reduced to eliminate externally introduced acid neutralization capability of the dilution solution.

Preferably the un-separated electrochemical cell and/or the separated electrochemical cell contains an anode and/or a cathode comprised of a platinum group metal. Also preferably, the anode, the cathode, or both, are coated with a precious metal that may be, for example, iridium oxide. Hypochlorite generated by the first electrochemical cell is preferably at a concentration of about 1,000 to 10,000 mg/L, and more preferably 5,000 to 8,000 mg/L. Preferably, the un-separated electrochemical cell is at least 50% efficient at converting the chlorine content of the brine solution to hypochlorite, more preferably at least 75% efficient, more preferably at least 80% efficient, more preferably at least 85% efficient, more preferably at least 90% efficient, and even more preferably at least 95% efficient.

Preferably the un-separated electrochemical cell has an aspect ratio, height to diameter, of from about 10:1 to 5:1 and is housed in a pipe structure. Preferably one or more of the cells are completely submerged within the brine and preferably submerged from 25 cm to 60 cm below a surface of the brine. Polarity of current to the un-separated electrochemical cell or the separated electrochemical cell may be periodically reversed to eliminate scale that accumulated on the electrodes, and electrodes of either cell may be in a monopolar arrangement or a bipolar arrangement. Preferably, the electrochemical cells produce gas that continuously mix the brine solution. Also preferably, each electrochemical cell produces a minimal amount of residual salt such as, for example, sodium salt and at less than about 1,000 ppm or, preferably, less than about 50 ppm.

The diluting comprises adding a volume of an aqueous liquid to reduce the hypochlorite concentration. The liquid is preferably water or a light brine, but may be any aqueous fluid that does not interfere with downstream use of the product or interfere with the process steps. Preferably, the hypochlorite is diluted to a concentration of about 2 to 1,000 ppm and more preferably to about 10 to 500 ppm. The amount of dilution typically depends on the desired use of the final product. Dilution also reduces that pH from about 8.5 to 9.5, to about 6.8 to 8.0. Preferably, pH of the diluted solution is from about 7.0 or less to about 8.5.

The separated electrochemical cell preferably contains an ion exchange membrane, a diaphragm, or a microporous separator between the electrodes which prevents the transfer of hypochlorous acid. Also preferably, voltage and amperage of the unseparated electrochemical cell and/or the separated electrochemical cell are regulated so that current to each is relatively constant during the process. Preferably, the pH of the second solution is from about 5 to 6.8. The invention is further directed to a solution of hypochlorous acid produced by the process of the invention.

Another embodiment of the invention is directed to a continuous-batch process comprising repeatedly exposing a stream of brine from a fixed volume batch source to an electrical energy such that hypochlorite and hypochlorous acid production is proportional to electrical energy imparted to the brine over a period of time, both in the cell tank and from the batch tank source. Preferably, the period of time is from 1 to 12 or 24 hours, or for multiple days, or longer. In his embodiment, brine is continuously fed to the unseparated cell, transferred to another tank for dilution, then fed to the separated cell.

Another embodiment of the invention is directed to systems and devices for generating hypochlorous acid comprising: a container containing a solution that comprises chlorine; an unseparated electrochemical cell which subjects an aqueous solution containing chlorine to electrical energy; and a separated electrochemical cell to which is provided the aqueous solution that has been treated by the unseparated electrochemical cell. Preferably the system further comprises one or more of fluid pumps, agitators or mixers. Also preferably, the system is operated at a voltage and amperage to each of the unseparated electrochemical cell and the separated electrochemical cell so that current to each is relatively constant during operation of the system.

Other embodiments and advantages of the invention are set forth in part in the description, which follows, and in part, may be obvious from this description, or may be learned from the practice of the invention.

### DESCRIPTION OF THE FIGURES

FIG. 1 Percent fraction of chlorine, hypochlorous acid, and hypochlorite from a pH of 0 to a pH of 14.

FIG. 2 Graphic representation of current efficiency vs. salinity.

FIG. 3 Amount of free chlorine in the hypochlorous acid of one embodiment of the invention as compared with direct electrochemical separation.

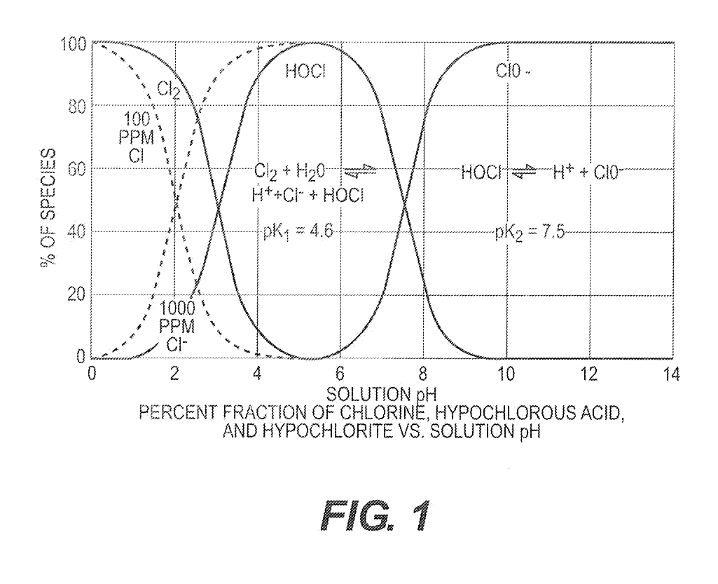

### DESCRIPTION OF THE INVENTION

Conventional processes to manufacture chlorine species for disinfection involve injecting chlorine into a water stream under pressure. The chlorine dissolves into the water forming hypochlorous acid and hypochlorite. The dangers of handling and transporting chlorine gas and the many personnel hazards it presented drove the development of alternative processes to make chlorine species on site.

It has been surprisingly discovered that high concentrations of hypochlorous acid can be produced from the same and similar starting materials, with minimum salt production and reduced power consumption as compared to conventional processes, and at high operating efficiencies. This is accomplished by separating the system into two operations, each of which is preferably optimized.

The first system generates hypochlorite in at least one un-separated electrochemical cell to make about 0.8% hypochlorite at a pH of about 8 to 9. An unseparated electrochemical cell is one in which there is no barrier between the electrodes. Multiple cells can be used depending on the overall volume of liquid and time desired. This solution can be stored, as produced or diluted, for weeks or months if required without significant degradation of the hypochlorite. Storage temperatures arc preferably at room temperature or less. When hypochlorous acid is required, the concentrated hypochlorite can be diluted typically to about 4 to 500 mg/L as chlorine with a drop in the pH value as the alkalinity of the hypochlorite is neutralized by natural acidity in the diluting water. This diluted chlorine stream is then fed to the anode of a second electrochemical cell where the remaining alkalinity is neutralized by protons formed at the anode, thus forming hypochlorous acid.

One embodiment of the invention is directed to a process for efficient generation of hypochlorous acid with low residual salt. This process employs at least two electrochemical cells, the first of which has no separator between the anode and cathode and generates a high-strength hypochlorite solution. This solution can be stored for hours, days, weeks or months, as desired. When ready for use, the hypochlorite is then diluted to a desired chlorine concentration and/or pH and fed into the anode compartment of a second electrochemical cell wherein the electrodes are separated by a barrier, such as, for example, a membrane or diaphragm that prevents transfer of certain chemicals or chemical species between the electrodes. The separated cell produces a solution containing predominantly hypochlorous acid. Further, the pH can be adjusted so that hypochlorous acid is the prevalent species. Surprisingly, the amount of hypochlorous acid produced is greater than conventional procedures and produced in less time and with greater current efficiency. The process of the invention can be operated sporadically for multiple hours at a time, or continuously for multiple days with the constant influx of fresh brine.

The starting solution is an alkaline metal chloride such as, for example, potassium chloride, calcium chloride and is most typically brine, but may be seawater or water to which is added salt. The solution is typically at room temperature or less, such as 20° C., 15° C., 10° C., 4° C. or 2° C., and the salt is typically sodium chloride. Although the description herein refers to sodium chloride, one skilled in the art can appreciate that the process is adaptable to many other types of salts of chlorine besides sodium salts. NaCl is the preferred starting materials and at concentrations of from 5 to 40 grams of salt per liter, more preferably from 10 to 35 grams per liter, and more preferably from 15 to 30 grams per liter. Both higher and lower concentrations are also possible depending upon a number of factors including type of salt, time period, liquid volume, and desired use.

The starting solution, preferably a high-strength salt brine with about 20 to 36 grams of NaCl per liter, is provided to a first electrochemical cell. Of course, additional electrochemical cells can be used simultaneously with large volumes of brine solution to increase the speed of treatment, and/or shorten the amount of time required for treatment.

The salt is then electrolyzed by the cell which has no separator between the anode and cathode. Preferably the electrochemical cell is filled with brine and operated until the chlorine concentration reaches the desired level. Preferably one or both of the electrochemical cells are submerged in the starting brine solution and below the surface of the brine by at least 25 cm and preferable at least 60 cm. The flow or stream of fluid in and around the electrochemical cells is generated by gas lift, thus the brine is repeatedly exposed to the electrolytic cell. As can be appreciated, the system may include other devices for agitating the fluid such as, for example, pumps, propellers, and similar devices that encourage mixing and/or drive solution to enter the electrochemical cell.

Current, preferably DC, applied to the brine solution by the electrochemical cell may be continuous or pulsed and preferably pulsed at increased levels from continuous to provide a similar conversion to hypochlorite with increased conversion efficiency. The electrochemical cell provides for the formation of chlorine at the anode which is immediately hydrolyzed to form a hypochlorite ion and a hydrogen ion at the cathode. These conditions allow excellent efficiency for formation of hypochlorite, with current efficiency of preferably at least 70% or greater, more preferably 80% or greater, more preferably 90% or greater, and even more preferably 95% or greater. The hypochlorite thus formed has a terminal pH of from about 7 to 9.5, although may be higher, and is preferably from about 8 to 9. If needed or desired, the polarity of current to the un-separated electrochemical cell may be periodically reversed to eliminate or assist in eliminating scale that accumulated on the electrodes.

Typical hypochlorite concentrations generated from the first electrochemical cell are from about 5,000 ppm to 10,000 ppm as free available chlorine, preferably less than about 10,000 mg/L, and more preferably between about 5,000 to 8,000 mg/L. The undiluted solution is basic with a pH of 8.0 or greater, preferably 8.5 or greater, more preferably 9.0 or greater, and more preferably 9.5 or greater. These concentrations and at he preferred pH ranges can be stored, and safely, for long periods of time, such as days, weeks, or months, with little or no degradation of the hypochlorite.

This solution is then diluted to obtain the desired chlorine concentration and fed into a separated cell that generates essentially 100% oxygen and acid to reduce the pH into the range where hypochlorous acid is the predominant species. In this fashion no current is wasted making protons that must be subsequently neutralized. Also separating the cells ensures that neutralization generates almost all protons making pH control much easier for those skilled in the art. Dilution is with an aqueous solution, preferably water or another salt solution, to generate a desirable concentration of chlorine and/or a desirable pH. For example, desired chlorine concentrations, depending on the intended us, are from 1 to 200 mg/L, from 10 to 300 mg/L, from 50 to 500 mg/L, 100 to 2.000 mg/L, from 1,000 to 5,000 mg/L and from 3,000 to 6,000 mg/L. Desired pH is from about 4 to about 8.5, preferably from about 5 to about 8.0, and more preferably from about 6 or 6.5 to about 7.0 or 7.5, or more preferably from about 6.8 to about 7.4. The dilution may be with the addition of a volume of an aqueous solution of the treated brine solution. Preferably, the amount of dissolved solids and alkalinity in the brine solution make-up water is reduced to eliminate the externally introduced acid neutralization capability of the make-up water.

The diluted hypochlorite solution is subsequently passed through the electrodes of at least one electrolytic cell separated by a diaphragm or membrane. Preferably, the diaphragm or membrane is microporous or an ion exchange, which may be an anion exchange or a cation exchange membrane.

Protons generated at the anode neutralize the base of the hypochlorite forming hypochlorous acid. Since much of the base value of the hypochlorite is neutralized by the naturally occurring acidity and buffers of the dilution water, overall efficiency of second electrochemical cell and the overall process is optimized. Another benefit is that the amount of residual salt in the hypochlorous acid thus formed is significantly lower than other types of processes that generate hypochlorous acid more directly. The amount of residual salt produced is typically less that about 1,000 mg/L, preferably less than about 750 mg/L, more preferably less than about 500 mg/L, more preferably less than about 250 mg/L, and even more preferably less than about 100 mg/L.

The overall process design comprises at least two different electrochemical cells which may contain electrodes in a monopolar or bipolar arrangement. It is preferred that the electrodes of one or both types of cells contain an anode and/or a cathode comprised of a platinum group metal. Also preferably, the anode, the cathode, or both, are coated with a precious metal that may be, for example, iridium oxide. Also, the cells may be housed in a pipe structure. The cell and pipe structure preferably has an aspect ratio, height to diameter, of from about 10:1 to 5:1, or another suitable size and structure suitable for the machinery.

The system may be a batch process, whereby individual batches of salt solution are processed, or a closed loop production process whereby one stream of brine from a fixed volume batch source is repeatedly exposed to electrical energy as it cycles through the first cell and the second cell. For the batch process, solution is discharged from the first cell tank. The discharged, chlorinated water can be diluted and fed into the second electrochemical cell where it is acidified to the desired value, again by the close loop continuous batch production. Alternatively, the first electrochemical cell is operated as stated except the strong chlorinated water is fed into another tank which acts as an accumulator. In this fashion electrochemical cell one is used on a continuous basis. One advantage of this approach is that this cell accumulates highly chlorinated solution during off-peak time and effectively increases the instantaneous capacity.

With either system, there may be agitators for mixing the solution as described here, and/or pumps for moving the solutions through and between the electrochemical cells. The resulting hypochlorous containing solution may be used immediately or stored for a period of time, preferably at room temperature or less, before use.

The amount of hypochlorous acid in the final solution after processing through the system of the invention is greater than is achieved from conventional processes that use a lower concentration of salt in the initial solution. Preferably the efficiency of conversion of sodium chloride of the initial solution to hypochlorous acid of the final solutions is up to 70%, up to 75%, up to 80%, up to 85%, up to 90%, or up to 95% or more.

The process of the invention provides reduced overall power consumption as compared to other conventional procedures, low salt levels in the final product also as compared to other conventional procedures, and simplicity of design. Further, separation of the neutralization processes allows storage of hypochlorite which has a much greater stability with regard to temperature which can then be subsequently converted into hypochlorous acid at point of use or as demanded.

Another embodiment of the invention is directed to systems and devices for performing the process of the invention. The system comprises at least two electrochemical cells, the first of which generates a high strength hypochlorite without a separator between the anode and cathode. This solution is then diluted to a desired chlorine concentration and fed into the anode compartment of a second electrochemical cell where the pH is adjusted to within the range where hypochlorous acid is the prevalent species. Again, the system may include agitators, pumps and other devices that promote fluid movement and/or mixing. The first electrochemical cell utilizes relatively high-strength salt brine, preferably about 20 to 30 grams per liter, which is electrolyzed without a separator between the anode and cathode. Chlorine is formed at the anode and immediately hydrolyzed to form hypochlorite ion. Hydrogen is generated at the cathode. The hypochlorite thus formed has a terminal pH of preferably about 8 to 9. The hypochlorite is then diluted with water to generate a desirable concentration which is preferably from 2 to 1,000 mg/L, or more preferably from about 5 to 500 mg/L.

The diluted hypochlorite solution is subsequently passed through the anode chamber of an electrolytic cell separated by a diaphragm or membrane. Protons generated at the anode neutralize the base of the hypochlorite forming hypochlorous acid. Preferably, the separated electrochemical cell contains a microporous separator between the electrodes and said microporous separator does not allow passage of hypochlorous acid. Alternatively the separated electrochemical cell contains a diaphragm between the electrodes. Since much of the base value of the hypochlorite is neutralized by the naturally occurring acidity and buffers of the dilution water, overall efficiency of the process is optimized.

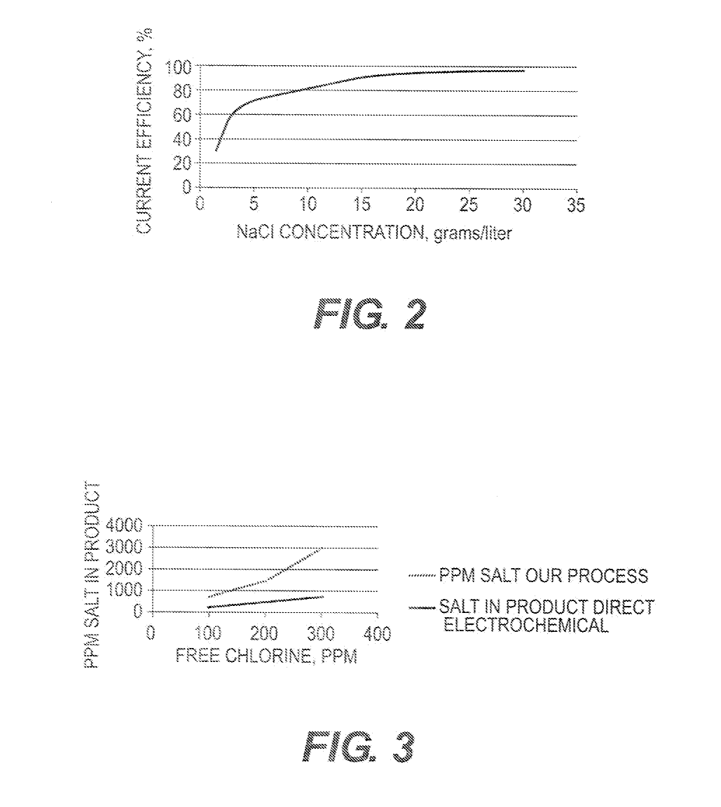

According to the preferred processes of the invention, the operating efficiency of a hypochlorous acid generator is maximized. To accomplish this, the efficiency of chlorine generation at the anode is maximized. It is preferred to use higher salinity to maximize the amount of current that is used to make chlorine in lieu of oxygen and protons. As salt concentration is decreased, the efficiency for chlorine generation falls dramatically (FIG. 2). This is due in part to the limitation of chlorine diffusion to the anode. The remainder of the current converts water to oxygen and hydrogen. The present invention generates chlorine (as hypochlorite) in the region of high efficiency or from about 20 to 30 grams per liter of salt. The present invention also minimizes cell voltage and therefore power consumption since the salinity is high resulting in high conductivity.

It is also preferred to minimize residual salt concentration in the chlorinated water after dilution since the many applications for hypochlorous acid are in the food and agricultural area. The present invention limits salt in the diluted product to far below traditional methods for making hypochlorous acid. As an example, hypochlorite solution of 0.8% (8,000 ppm) made from 28 grams per liter brine is diluted to a chlorine concentration of 100 mg/L, the salt concentration is only 250 mg/L. Traditional methods for making hypochlorous acid result in much higher salt concentration, FIG. 3.

The invention provides an improved process for generation of hypochlorous acid that reduces overall power consumption, lower salt concentration, and simplicity of design. This is achieved by optimizing the chlorine generation efficiency by making hypochlorite at high salinity in a first electrochemical cell that does not employ any separator between anode and cathode. Further, the voltage and amperage of both the unseparated electrochemical cell and the separated electrochemical cell are regulated so that current to each is relatively constant during the process. This allows for reduced current as compared to conventional processes.

The following examples illustrate embodiments of the invention, but should not be viewed as limiting the scope of the invention.

### EXAMPLES

An example is shown below to demonstrate the overall power savings of the instant invention:

### Example 1 (Prior Art)

Hypochlorous acid generator wherein a single generator is fed low salinity brine and the pH is controlled by mixing material produced at the cathode to the anode stream. A comparison of the prior art process with the process of the invention is provided in Table I.

Current Efficiency: 30% at 2,000 ppm salt concentration (see FIG. 2)
Target free chlorine in acid stream: 250 mg/L
Flow rate: 1 liter per minute
Current: 37.88 amps
Estimated cell voltage: 10 VDC
Power to produce 250 mg/L free chlorine in 1 liter per minute water: 378 watts
Residual salt in hypochlorous acid: 1,100 mg/L

### Example 2

### Hypochlorous Acid Generator per the Instant Invention

Electrochemical cell #1: hypochlorite generator
Current efficiency: 85% at 25 grams/liter salt (FIG. 2)
Estimated cell voltage, first electrochemical cell reaction: 4 VDC
Power to produce 250 mg/L free chlorine at 1 liter per minute: 53 watts
Electrochemical cell #2: Neutralization of hypochlorite
Amps to reduce pH from between 8.5 and 9.0 to 6.1:
Cell voltage: 5 volts
Power: 31.7 watts
Overall Power consumption: 53+31.7=84.7 watts
Residual salt in hypochlorous acid: 500 mg/L

TABLE I
Summary

| | Power consumption for | Residual |
|---|---|---|
| | 250 ppm free chlorine at | salt |
| Type generator | 1 liter per minute | mg/L |
| Prior art single electrochemical cell | 378 | 1,100 |
| hypochlorous acid generator | | |
| Instant invention utilizing two | 84.7 | 500 |
| electrochemical cells | | |

Other embodiments and uses of the invention will be apparent to those skilled in the art from consideration of the specification and practice of the invention disclosed herein. All references cited herein, including all publications, all U.S. and foreign patents and patent applications, and all other publications are specifically and entirely incorporated by reference. The term comprising, where ever used, is intended to include the terms consisting and consisting essentially of. Furthermore, the term comprising, including, and containing are not intended to be limiting. It is intended that the specification and examples be considered exemplary only with the true scope and spirit of the invention indicated by the following claims.

1. A process for generating hypochlorous acid comprising:
providing a brine solution with a chlorine content to un-separated electrochemical cell containing electrodes to generate a first solution containing a hypochlorite;
diluting the first solution with an aqueous liquid and form a diluted solution; and
providing the diluted solution to a separated electrochemical cell containing electrodes that generates protons to form a second solution comprised of a hypochlorous acid.

2. The process of claim 1, wherein the brine solution comprises about 15 to 40 grams of NaCl per liter.

3. The process of claim 1, wherein the brine solution is seawater, manufactured salt water or softened water.

4. The process of claim 1, wherein the un-separated electrochemical cell or the separated electrochemical cell contains an anode or a cathode comprised of a platinum group metal.

5. The process of claim 4, wherein the anode or cathode is coated with iridium oxide.

6. The process of claim 1, wherein the un-separated electrochemical cell has an aspect ratio, height to diameter, of from about 10:1 to 5:1 and is housed in a pipe structure.

7. The process of claim 1, wherein the electrodes of the un-separated electrochemical cell are in a monopolar arrangement or a bipolar arrangement.

8. The process of claim 1, wherein the un-separated electrochemical cell produces gas that continuously produces uplifting and mixing of the brine solution.

9. The process of claim 1, wherein the un-separated electrochemical cell produces an amount of residual salt.

10. The process of claim 9, wherein the amount of residual salt is about 50 to 1,000 ppm.

11. The process of claim 1, wherein the hypochlorite generated by the first electrochemical cell is at a concentration of about 1,000 to 10,000 mg/L.

12. The process of claim 1, wherein the hypochlorite generated by the first electrochemical cell is at a concentration of about 5,000 to 8,000 mg/L.

13. The process of claim 1, wherein the un-separated electrochemical cell is at least 50% efficient at converting the chlorine content of the brine solution to hypochlorite.

14. The process of claim 1, further comprising storing the first solution for a period of time either before or after diluting with the aqueous liquid.

15. The process of claim 14, wherein the period of time is from 1 to 30 days.

16. The process of claim 14, wherein the first solution is stored at room temperature of less.

17. The process of claim 1, wherein hypochlorite concentration of the diluted first solution is from about 2 to 1,000 ppm.

18. The process of claim 1, wherein hypochlorite concentration of the diluted first solution is from about 100 to 600 ppm.

19. The process of claim 1, wherein the un-separated electrochemical cell or the separated electrochemical cell is completely submerged within the brine.

20. The process of claim 1, wherein the submerged cell is from 25 cm to 60 cm below a surface of the brine.

21. The process of claim 1, wherein the polarity of current to the un-separated electrochemical cell or the separated electrochemical cell is periodically reversed to eliminate scale that accumulated on the electrodes.

22. The process of claim 1, wherein the aqueous liquid is water.

23. The process of claim 1, wherein the pH of the first solution is reduced from about 8.5 to 9.5, to about 6.8 to 8.0 in the diluted solution.

24. The process of claim 1, wherein pH of the diluted solution is from about 7.0 to 8.5.

25. The process of claim 1, wherein the separated electrochemical cell contains an ion exchange membrane between the electrodes.

26. The process of claim 1, wherein the separated electrochemical cell contains a microporous separator between the electrodes and said microporous separator does not allow passage of hypochlorous acid.

27. The process of claim 1, wherein the separated electrochemical cell contains a diaphragm between the electrodes.

28. The process of claim 1, wherein voltage and amperage of both the unseparated electrochemical cell and the separated electrochemical cell are regulated so that current to each is relatively constant during the process.

29. The process of claim 1, wherein pH of the second solution is from about 5 to 6.8.

30. The process of claim 1 wherein dissolved solids and alkalinity in the brine solution is reduced to eliminate externally introduced acid neutralization capability of the aqueous liquid.

31. The process of claim 1, which is a closed-loop, continuous-batch process comprising: repeatedly exposing a stream of brine from a fixed volume batch source to an electrical energy proportional to a total volume of exposed brine.

32. A solution of hypochlorous acid produced by the process of claim 1.

33. A closed-loop, continuous-batch process comprising: repeatedly exposing a stream of brine from a fixed volume batch source to an electrical energy such that hypochlorite and hypochlorous acid production is proportional to electrical energy imparted to the brine over a period of time.

34. The process of claim 33, wherein the period of time is from 1 to 24 hours.

35. The process of claim 33, wherein the period of time is multiple days.

36. A system for generating hypochlorous acid comprising:
a container containing an aqueous solution that comprises sodium chloride;
an unseparated electrochemical cell that subjects the aqueous solution to electrical energy; and
a separated electrochemical cell to which is provided the aqueous solution that has been treated by the unseparated electrochemical cell.

37. The system of claim 36, further comprising one or more of fluid pumps, agitators or mixers.

38. The system of claim 36, further comprising one or more regulators so that current provided to both the unseparated electrochemical cell and the separated electrochemical cell is relatively constant during operation.

39. A process for generating hypochlorous acid comprising:
providing an alkaline metal chloride solution to a first, unseparated electrochemical cell submerged in the solution to generate a hypochlorite-containing solution wherein efficiency of conversion of the brine to the hypochlorite is at least 85%;
diluting the hypochlorite-containing solution with an aqueous liquid to reduce the hypochlorite concentration to less than 1,000 ppm forming a diluted solution; and
providing the diluted solution to a second, separated electrochemical cell which is submerged within the diluted solution and generates protons during operation that interact with the hypochlorite and form a solution of hypochlorous acid, wherein efficiency of conversion of the hypochlorite to hypochlorous is at least 85%.

40. The process of claim 39, wherein voltage and amperage to both the unseparated electrochemical cell and the separated electrochemical cell are individually regulated so that current to each is relatively constant during operation of the process.

41. The process of claim 39, wherein pH of the brine solution is reduced to eliminate externally introduced acid neutralization capability of the aqueous liquid.
